(19) United States
(12) Patent Application Publication
(10) Pub. No.: US 2014/0313056 A1
(43) Pub. Date: Oct. 23, 2014

(54) Companion Sympathetic Alert

(71) Applicant: George Allen Pallotta, The Woodlands, TX (US)

(72) Inventor: George Allen Pallotta, The Woodlands, TX (US)

(21) Appl. No.: 13/866,543

(22) Filed: Apr. 19, 2013

(51) Int. Cl. G08G 1/16

(52) U.S. Cl. CPC G08G 1/163
USPC 340/901

(57) ABSTRACT

A system and method for enabling a mobile device in motion to perform near field radiation monitoring functions while implementing an alert for a companion (in vehicle or adjacent to) when potentially unsafe conditions due to mobile device distracted driving may be about to occur with or to companions. Also, providing alerts through near-field monitoring of mobile device transmissions to passing by vehicles with potentially unsafe distractions.

### TECHNICAL FIELD OF INVENTION

This invention relates to mobile communications for mobile devices and more particularly to such a mobile device, when in motion, with near field mobile device transmission radiation monitoring including alerts.

### BACKGROUND

Mobile devices have evolved into multi-function communication terminals. While using these devices a multitude of functionalities are available to operators potentially creating death causing distractions to operators driving in vehicles. The potential distractions created by these mobile device functions affect all age groups; however, teen age operators are thought to be a group most in need of a method to stop distractions caused by mobile devices. The common wisdom in society appears to be that an adult “would know better” than to text while driving yet this also occurs. As stated by most States Driving Laws is the premise that Driving is a Privilege and the State assures certain capabilities and knowledge are possessed by an operator. Additionally, tests are given to validate an operator's abilities and performance. The subject mobile device distractions (from increased functionality) have only been introduced recently and how to deal with this hazard is just beginning. Parents have indicated that they don't want their children riding in a vehicle where an operator or anyone is distracted by mobile device communications. Even if Parents instruct their children on proper use of mobile devices will they listen, or will their companions listen? Parents would next like to have a device that would “knock out” such an offending device, but this would run afoul of the Federal Communications Commission.

What is needed is a capability to provide a mobile device with monitoring and alerts to potentially dangerous nearby functional interaction.

### SUMMARY

The companion sympathetic alert addresses the problem of nearby distracted driving by monitoring nearby device transmission through measuring of a nearby mobile device radiation signal strength. An application is incorporated into an operator's mobile device that monitors and measures nearby mobile device radiation and when a nearby signal strength radiation threshold is exceeded an indication is generated. The signal strength of a nearby device will be considerably stronger than a device that is farther away and thus less dangerous. As an example someone texting on a mobile device in the same vehicle (dangerous) will have a strong radiation emanation when compared to a mobile device a quarter of mile away (less dangerous). The basic laws of physics dictate that 1/distance squared applies to all radiating bodies. While many additional things affect radiation signal strength the basics hold for applications such as warning of immediate near-field signal strength radiation.

The companion sympathetic alert implements this principle by ignoring all but the immediate vicinity transmissions from mobile devices, ignoring lower power emissions from farther away devices. When immediate vicinity transmissions from nearby mobile devices are detected an alert is displayed. This alert can be in the form of visual (on screen), audio (a tone or short message from the speaker), or vibrate. Typically, any transmitting mobile device within ⅛^{th} of a mile will exceed the threshold and signal an alert to the operator with the application installed.

An operator with the companion sympathetic alert application installed has various options when an alert is given that a nearby mobile device is causing a potential hazard. A message can be sent by a simple button press to warn the nearby device of the potential hazard observation.

A record of the alert can be sent to the cell service provider to log the event. A record of the alert can be sent to the insurance provider to log the event. A “Please Stop” notice can be sent to companions.

The companion sympathetic alert runs resident and monitors signal strength of nearby mobile devices if desired only texting can be alerted as many mobile devices have “hands free” capabilities. No knocking out of signals is incorporated, only reminders and logging of events.

### BRIEF DESCRIPTION OF DRAWINGS

FIG. 1 depicts an in-vehicle nearby texting situation.

FIG. 2 depicts a nearby vehicle texting situation.

FIG. 3 depicts a typical companion sympathetic alert system diagram.

FIG. 4 depicts a typical companion sympathetic alert system operational flow.

FIG. 5 depicts a set of typical companion sympathetic alert display screens.

FIG. 6 depicts a typical device set up to incorporate companion sympathetic alert functionality.

### DETAILED DESCRIPTION OF DRAWINGS

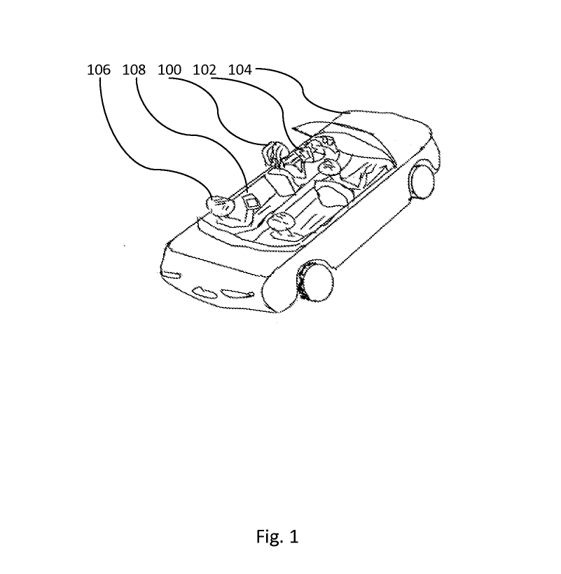

FIG. 1 depicts an in-vehicle nearby texting situation. The occupants of a vehicle 104 shown are traveling as normal occupants will, however, a driver 100 has taken out a mobile device 102 and has commenced with texting activities on the device 102. While the driver 102 may miss judge or otherwise alert the other occupants of the vehicle 104 of the texting operations a rear occupant 106 has a mobile device 108 with companion sympathetic (CSA) alert functionality. The device 108 with CSA is alerted to the potentially dangerous texting operation by the driver 100. The occupant 106 can warn the driver 100 of the dangers of texting while driving or send the driver 100 a warning message to cease the potentially dangerous operation(s).

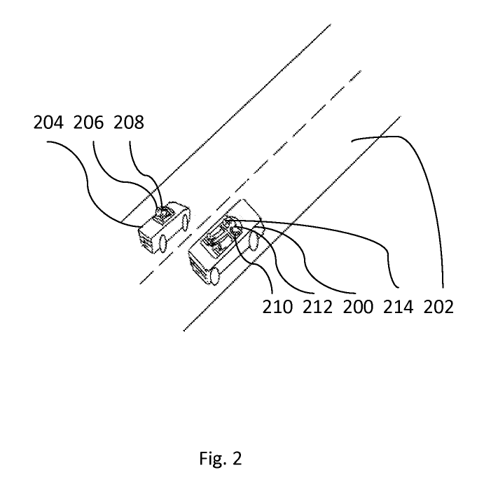

FIG. 2 depicts a nearby vehicle texting situation. A vehicle 200 is traveling down a two lane divided highway 202. The vehicle 200 is operated by a driver 214. A different vehicle 204 is passing vehicle 200 in an adjacent lane. A driver 206 operating vehicle 204 has initiated texting on a mobile device 208 while driving. An occupant 210 riding in vehicle 200 has a mobile device 212 with companion sympathetic (CSA) operating; CSA alert is displayed on device 212 alerting occupant 210 that a potentially unsafe operator is in the vicinity. While typical occupants are not authorized to intervene with potentially unsafe operations of a vehicle such as is occurring with vehicle 204 the alert can cause the occupants of vehicle 200 to alert their driver 214 to be extra cautious and give nearby vehicles a “wide birth” to avoid contact.

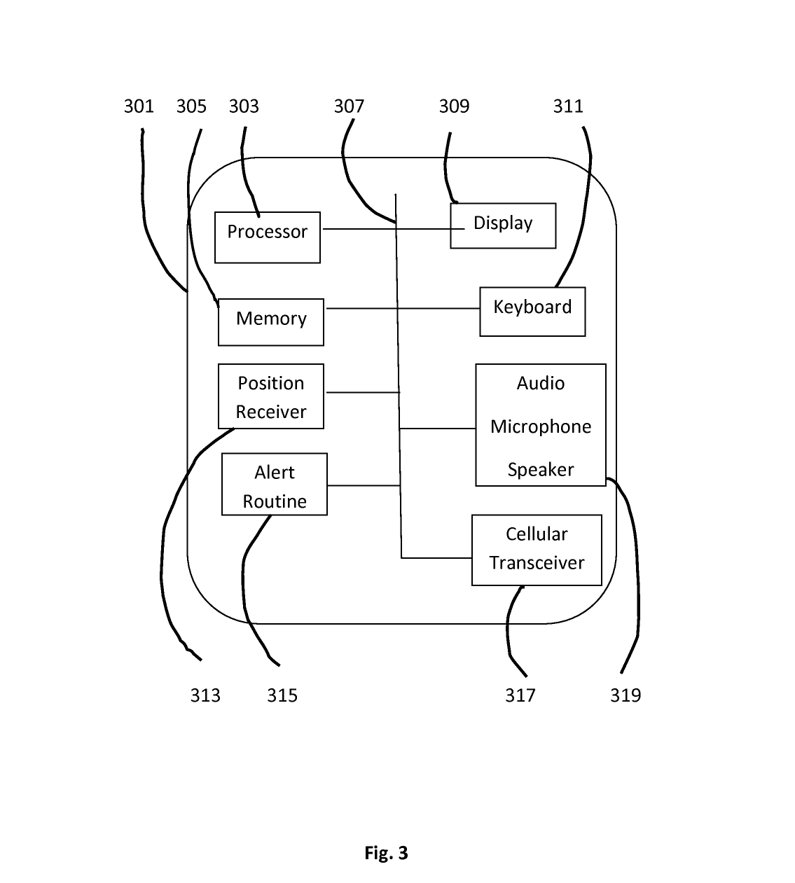

FIG. 3 depicts a typical companion sympathetic alert system diagram. A companion sympathetic (CSA) system block diagram 301 of device 102 (FIG. 1) is typically centered around a system bus 307 that features a processor 303 to coordinate and operate machine readable code and routines a portable device communication functions. A memory 305 module is shown to store and make available to the processor 303 machine readable code and routines. A position/location receiver 313 such as a GPS receiver is shown to track and provide location information of the device 102 (FIG. 1). A machine readable velocity determining and signal strength monitoring routine 315 is shown that supplies routines to the processor 303 periodically reviews position/location information from a receiver 313 and memory 305 and determines if a threshold of velocity for the device 102 is reached and monitors nearfield device signal strength (nearby devices) and when a preset threshold is exceeded provides an alert to the processor 303. The processor 303 will evaluate signals that appear close (very strong signal strength) for sustained use (indicating activity that could be distracting) and send an alert to a display 309, an audio indicator, or a vibrator alert. A keyboard 311 is also provided for operator entry and response, the keyboard could be a discrete device or on screen and while additional complementary keyboard devices such as trackballs, mice, touch screens, or similar devices are not shown they should be considered extensions of the device 102 entry systems. An audio 319 interface is shown typically consisting of a speaker or set of speakers, a microphone. While not shown communication interfaces to a vehicle communication system by wire or wirelessly (such as Bluetooth or WiFi) should be considered extension of this invention. A cellular transceiver 317 is shown to connect the device 102 to the provider's towers and central office as shown in previous figures. All signal strength measurements by device 102 are in band to the device 102 frequencies.

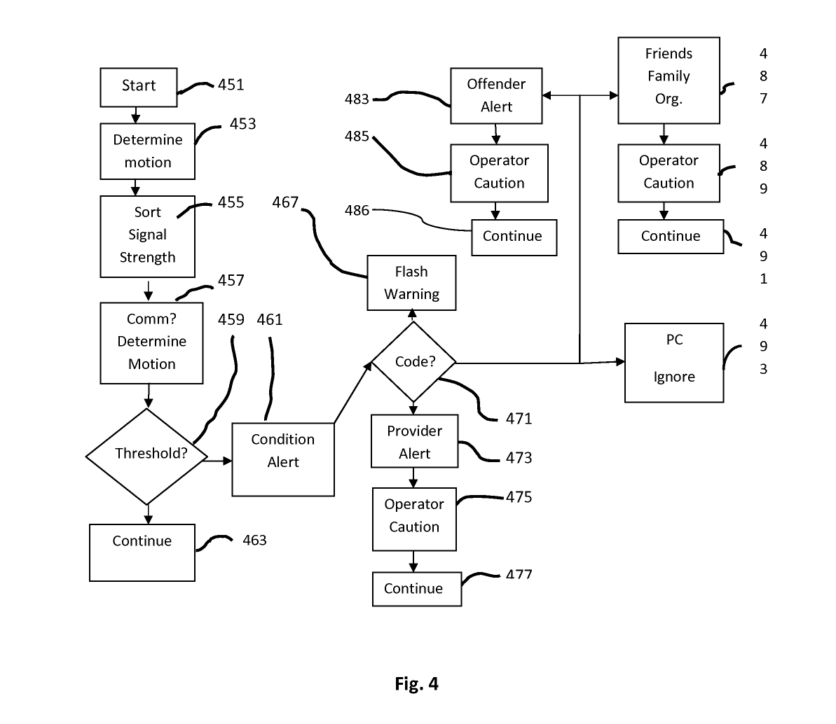

FIG. 4 depicts a typical companion sympathetic alert system operational flow. The companion sympathetic (CSA) inhibit routine consisting of machine readable and executable code for a portable communication device initiates with a start block 451 that initiates when the device 102 (FIG. 1) is turned on. A determine motion block 453 implements the processor periodically reviewing position/location information from the receiver and memory to determines if a threshold of velocity for the device 102 is reached. The block 453 routine will wait a short period and reread the device position from the receiver and when multiple determinations of motion exceeding the threshold are achieved the device 102 is considered in motion beyond the threshold. When device 102 is considered in motion a sort signal strength monitoring block 455 evaluates near field signal strength from other mobile devices. When in band near field signal strength exceeds the pre-established threshold (indicating an active mobile device is nearby) a series of multiple measurements is implemented to determine if the nearby device is performing sustained use, indicating potential nearby hazards and to avoid aliasing. Next a decision block 459 determines if the nearby device poses a potentially hazardous condition. If the velocity threshold for the device 102 is reached and the nearby device has exhibited sustained use a condition alert block 461 is entered. If all conditions are not met a continue block 463 is entered and the system will return to the start block 451 to continue monitoring of device motion and near field transmission radiation signal strength. When condition alert box 461 is entered the system will determine which code is operating in code box 471. A standard system operation is a flash warning box 467. The box 467 will typically provide the device 102 with a visual screen alert, an audio notification, and vibrate. The system (operator selection) can provider alert box 473 sends a record of the near field device record to the service provider, a message to the nearby device by operator caution box 475 and into continue box 477. Additionally, an offender alert box 483 can send a direct alert to the offending nearby device and operator caution box 485 alerts device 102 that the condition remains and a message was sent to the nearby device. Following box 485 a continue box 486 is entered and the system will return to start 451. Also, a friends, family, and organization(s) box 487 provide personal code exceptions for alerts when Bluetooth headsets, pre-determined events, or functions are entered. An operator caution 489 will still be sent to device 102 but in the background as an exception has been determined. Following box 489 a continue box 491 is entered and the system will return to start 451. Further, a personal code PC ignore box 493 will stop monitoring until the personal code is removed and normal operations are reinstated.

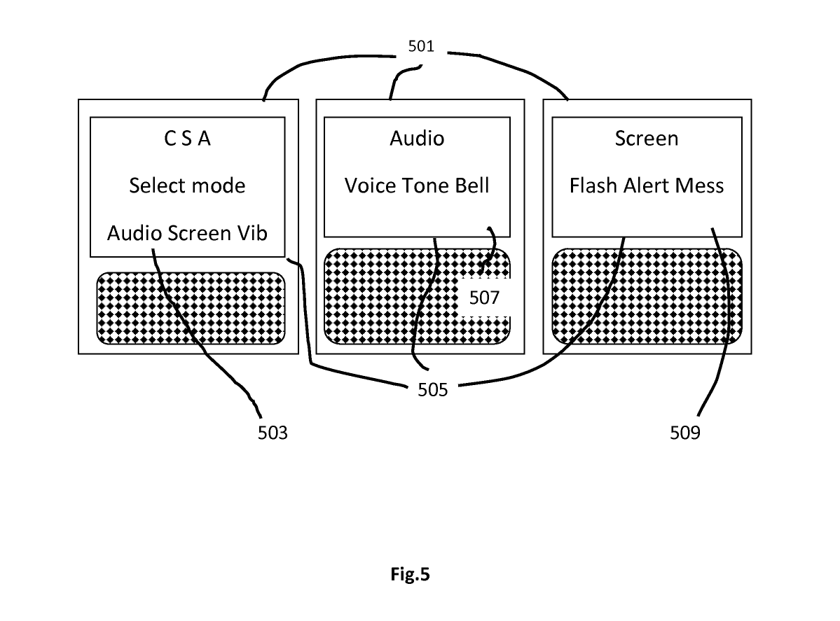

FIG. 5 depicts a set of typical companion sympathetic alert display screens. The companion sympathetic alert (CSA) alert screens are shown on a mobile device 501. A CSA screen 503 allows the operator to select the desired mode on a mobile device screen 505. The operator can choose audio, screen or vibrate or any combination of alerts by selecting the desired alert. A further choice for audio is provided on a device screen 507 where the operator can select voice, tone or bell for type of audio alert. A further choice for screen type is provided on a screen 509 where an operator can select from a screen flash, alert, or message alert.

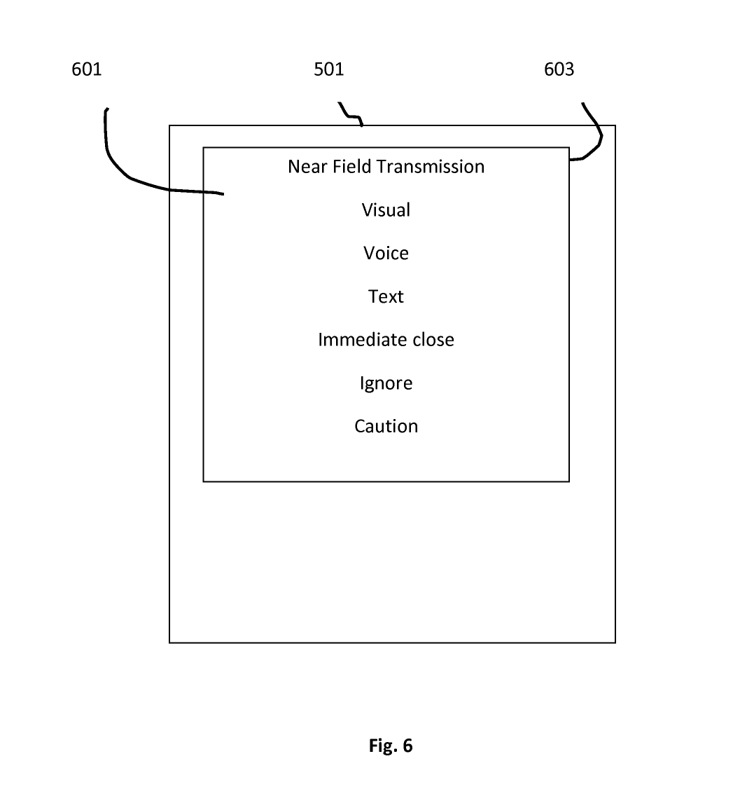

FIG. 6 depicts a typical device set up to incorporate companion sympathetic alert functionality. A set up of a companion sympathetic (CSA) system has a device 501 a screen message 601 displayed on a device screen 603. Near Field Transmission. Visual Voice Text Immediate close. Ignore. Caution. The operator will select “Near Field Transmission” and choose the desired type of Visual display, either simple ALERT, flashing ALERT, or no Visual can be selected. Next, a Voice alert or no Voice alert can be selected. Next, the operator can choose to select a code to send a text to home, carrier provider, or nearby offender (additionally, an insurance provider can be alerted). Additional options can be selected by code entry to acknowledge with a press of “Immediate Close” to indicate warning observed. Also, an Ignore button may be selected for cessation or alerts during difficult driving moments. And, a Caution can be kept in display during the duration of the potential hazard. An Ignore message is typically implemented with Personal Code which is 411 by default, the operator can change this number to a more appropriate 3 digit number by entering the replacement number in the box below Personal Code. Immediately below the Personal Code box is Emergency Code with 911 in the code box below Emergency Code the operator can change this number to adapt to regional emergency codes. When OK is selected these values will be recorded and be part of any override message. Set up of CSA values will typically be restricted with code protection to prohibit casual or otherwise changing setting of a device.

In incidents such as:
government vehicles
city busses/school busses
private delivery companies
parents of children under 18 years of age,
other as specified.

Have the authority to turn that option off and/or unauthorized to the user of the vehicle from even confirming such a task, because there will be individuals that will take advantage of such.

### Operation

An operator will simply go to the Companion Sympathetic Alert website or approved providers and download the application into the operator's desired device. The FIG. 5 screens will guide the operator through the necessary set up steps. When the set up is complete the operator will enjoy the safety benefits of the Companion Sympathetic Alert functionality as described in FIG. 6.

What is claimed is:

1. A control system for enabling a mobile device in motion to perform as a near field monitoring device with a caution alert, also implementing a mobile device alert when potentially unsafe distractions may be about to occur with or to companions comprising:
a processor,
a memory,
a storage capability,
a cellular radio,
a connection to a cellular network,
a routine for measuring momentum,
an ability to monitor near field cellular radio broadcasts,
a signal strength of near field cellular radio broadcasts measuring capability,
a signal strength threshold set level for near field companion hazards,
a signal strength near field measuring multiple times to avoid aliasing,
an alert to operator,
a safety override facility where the operator enters a preset emergency code (such as 911 or similar predetermined emergency number) bypassing the inhibit,
a personal responsibility override where the operator enters a preset personal code bypassing the alert,
a time delay set level for cessation of momentum to reset alerts, and
wherein the communications device is alerted to all types of communications and other usages for safety and responsibility purposes when the device is in motion above a preset threshold.

2. The control system of claim 1 wherein; the companion sympathetic alert routine runs continuously in the processor background.

3. The control system of claim 1 wherein; the companion sympathetic alert routine discontinues when the mobile device ceases motion.

4. The control system of claim 1 wherein; the companion sympathetic alert routine notifies mobile device operator with a choice of audio, visual (mobile device screen), or vibrate as selected by mobile device operator during system set up.

5. The control system of claim 1 wherein; the companion sympathetic alert routine notifies cellular provider of near field event.

6. The control system of claim 1 wherein; the companion sympathetic alert routine notifies other mobile device operator with a message of caution if selected by mobile device operator during system set up.

7. The control system of claim 1 wherein; the companion sympathetic alert routine notifies other parties as selected by mobile device operator during system set up.

8. The control system of claim 1 wherein; the companion sympathetic alert routine will cease alert(s) to the mobile device operator when an emergency code is entered.

9. The control system of claim 1 wherein; the companion sympathetic alert routine will cease alert(s) to the mobile device operator when a personal code is entered.

10. The control system of claim 1 wherein; the companion sympathetic alert routine works with the mobile device on in band mobile device radiation transmissions to determine hazards.

11. A method of internally measuring near field emanations of nearby mobile devices when a mobile device is in motion producing a caution alert, also implementing a mobile device alert when potentially unsafe distractions may be about to occur with or to companions the method comprising:
processing device motion,
initiating device status from a memory,
implementing a storage capability,
measuring device status from memory,
providing a cellular radio,
connecting to a cellular network,
implementing a routine for measuring momentum,
implementing an ability to monitor near field cellular radio broadcasts,
implementing a signal strength of near field cellular radio broadcasts measuring capability,
establishing a signal strength threshold set level for near field companion hazards,
implementing a signal strength near field measuring multiple times to avoid aliasing,
providing an alert to operator,
providing a safety override facility where the operator enters a preset emergency code (such as 911 or similar predetermined emergency number) bypassing the inhibit,
providing a personal responsibility override where the operator enters a preset personal code bypassing the alert,
implementing a time delay set level for cessation of momentum to reset alerts, and
alerting the operator of the mobile to all types of nearby communications and other usages for safety and responsibility purposes when the device is in motion above a preset threshold.

12. The method of claim 10 wherein; the companion sympathetic alert routine runs continuously in the processor background.

13. The method of claim 10 wherein; the companion sympathetic alert routine discontinues when the mobile device ceases motion.

14. The method of claim 10 wherein; the companion sympathetic alert routine notifies mobile device operator with a choice of audio, visual (mobile device screen), or vibrate as selected by mobile device operator during system set up.

15. The method of claim 10 wherein; the companion sympathetic alert routine notifies cellular provider of near field event.

16. The method of claim 10 wherein; the companion sympathetic alert routine notifies other mobile device operator with a message of caution if selected by mobile device operator during system set up.

17. The method of claim 10 wherein; the companion sympathetic alert routine notifies other parties as selected by mobile device operator during system set up.

18. The method of claim 10 wherein; the companion sympathetic alert routine will cease alert(s) to the mobile device operator when an emergency code is entered.

19. The method of claim 10 wherein; the companion sympathetic alert routine will cease alert(s) to the mobile device operator when a personal code is entered.

20. The method of claim 10 wherein; the companion sympathetic alert routine works with the mobile device on in band mobile device radiation transmissions to determine hazards.
